(19) United States
(12) Patent Application Publication
(10) Pub. No.: US 2024/0062057 A1
(43) Pub. Date: Feb. 22, 2024

(54) REGULARIZING TARGETS IN MODEL DISTILLATION UTILIZING PAST STATE KNOWLEDGE TO IMPROVE TEACHER-STUDENT MACHINE LEARNING MODELS

(71) Applicant: Adobe Inc., San Jose, CA (US)

(72) Inventors: Surgan Jandial, Jammu (IN); Nikaash Puri, New Delhi (IN); Balaji Krishnamurthy, Noida (IN)

(21) Appl. No.: 17/818,506

(22) Filed: Aug. 9, 2022

(51) Int. Cl. G06N 3/08; G06N 3/04

(52) U.S. Cl. CPC G06N 3/08; G06N 3/0454

(57) ABSTRACT

This disclosure describes one or more implementations of systems, non-transitory computer-readable media, and methods that regularize learning targets for a student network by leveraging past state outputs of the student network with outputs of a teacher network to determine a retrospective knowledge distillation loss. For example, the disclosed systems utilize past outputs from a past state of a student network with outputs of a teacher network to compose student-regularized teacher outputs that regularize training targets by making the training targets similar to student outputs while preserving semantics from the teacher training targets. Additionally, the disclosed systems utilize the student-regularized teacher outputs with student outputs of the present states to generate retrospective knowledge distillation losses. Then, in one or more implementations, the disclosed systems compound the retrospective knowledge distillation losses with other losses of the student network outputs determined on the main training tasks to learn parameters of the student networks.

### BACKGROUND

Recent years have seen an increase in hardware and software platforms that compress and implement learning models. In particular, many conventional systems utilize knowledge distillation to compress, miniaturize, and transfer the model parameters of a deeper and wider deep learning model, which require significant computational resources and time, to a more compact, resource-friendly student machine learning model. Indeed, conventional systems often distill information of a high-capacity teacher network (i.e., a teacher machine learning model) to a low-capacity student network (i.e., a student machine learning model) with the intent that the student network will perform similar to the teacher network, but with less computational resources and time. In order to achieve this, many conventional systems train a student machine learning model using a knowledge distillation loss to emulate the behavior of a teacher machine learning model. Although many conventional systems utilize knowledge distillation to train compact student machine learning models, many of these conventional systems have a number of shortcomings, particularly with regards to efficiently and easily distilling knowledge from a teacher machine learning model to a student machine learning model to create a compact, yet accurate student machine learning model.

### SUMMARY

This disclosure describes one or more implementations of systems, non-transitory computer readable media, and methods that solve one or more of the foregoing problems by regularizing learning targets for a student machine learning model by leveraging past state outputs of the student machine learning model with outputs of a teacher machine learning model to determine a retrospective knowledge distillation loss for teacher-to-student network knowledge distillation. In particular, in one or more implementations, the disclosed systems utilize past outputs from a past state of a student machine learning model with outputs of a teacher machine learning model to compose student-regularized teacher outputs that regularize training targets by making the training targets similar to student outputs while preserving semantics from the teacher training targets. Furthermore, within present states of training tasks, the disclosed systems utilize the student-regularized teacher outputs with student outputs of the present states to generate retrospective knowledge distillation losses. Indeed, in one or more implementations, the disclosed systems compound the retrospective knowledge distillation losses with other losses of the student machine learning model outputs determined on the main training tasks to learn parameters of the student machine learning models.

In this manner, the disclosed systems improve the accuracy of student machine learning models during knowledge distillation through already existing data from the student machine learning models while utilizing less computational resources (e.g., without utilizing additional external information and/or without utilizing intermediate machine learning models to train the student machine learning models).

### BRIEF DESCRIPTION OF THE DRAWINGS

The detailed description is described with reference to the accompanying drawings in which:

FIG. 1 illustrates a schematic diagram of an example environment in which a retrospective knowledge distillation learning system operates in accordance with one or more implementations.

FIG. 2 illustrates an overview of a retrospective knowledge distillation learning system determining and utilizing a retrospective knowledge distillation loss in accordance with one or more implementations.

FIGS. 3A and 3B illustrate a retrospective knowledge distillation learning system utilizing both a knowledge distillation loss and a retrospective knowledge distillation loss during teacher-to-student network knowledge distillation in accordance with one or more implementations.

FIGS. 4A and 4B illustrate a retrospective knowledge distillation learning system periodically updating a model state to utilize as an updated past-state output of a student network while training the student network using a retrospective knowledge distillation loss in accordance with one or more implementations.

FIG. 5 illustrates a schematic diagram of a retrospective knowledge distillation learning system in accordance with one or more implementations.

FIG. 6 illustrates a flowchart of a series of acts for regularizing learning targets for a student network by leveraging past state outputs of the student network with outputs of a teacher network to determine a retrospective knowledge distillation loss in accordance with one or more implementations.

FIG. 7 illustrates a block diagram of an example computing device in accordance with one or more implementations.

### DETAILED DESCRIPTION

This disclosure describes one or more implementations of a retrospective knowledge distillation learning system that leverages past state outputs of a student machine learning model to determine a retrospective knowledge distillation loss during knowledge distillation from a teacher machine learning model to the student machine learning model. In particular, in one or more embodiments, the retrospective knowledge distillation learning system determines a loss to train a student machine learning model using an output (e.g., output logits) of the student machine learning model and a combination of a historical output of a student machine learning model (e.g., from a previous or historical state) and an output of a teacher machine learning model for a training task. In one or more implementations, the retrospective knowledge distillation learning system determines a combined student-regularized teacher output by combining the historical output of the student machine learning model and the output of the teacher machine learning model. Additionally, in some cases, the retrospective knowledge distillation learning system determines a retrospective knowledge distillation loss from a comparison of the combined student-regularized teacher output and the output of the student machine learning model for the training task. Indeed, in one or more embodiments, the retrospective knowledge distillation learning system utilizes the retrospective knowledge distillation loss to adjust (or learn) parameters of the student machine learning model.

In some embodiments, during a training warmup phase, the retrospective knowledge distillation learning system utilizes a knowledge distillation loss based on outputs of a student machine learning model and outputs of a teacher machine learning model for a training task. In particular, the retrospective knowledge distillation learning system, during one or more time steps, receives outputs of student machine learning model for a training task. Moreover, the retrospective knowledge distillation learning system compares the outputs of the student machine learning model to outputs of a teacher machine learning model for the same training task to determine knowledge distillation losses. During these one or more time steps, the retrospective knowledge distillation learning system utilizes the knowledge distillation losses to adjust (or learn) parameters of the student machine learning model. In some cases, the retrospective knowledge distillation learning system utilizes a combination of the knowledge distillation losses and one or more additional losses determined using the outputs of the student machine learning models and ground truth data for the training task to learn parameters of the student machine learning model.

In one or more implementations, after a training warmup phase, the retrospective knowledge distillation learning system utilizes a combination of historical outputs of the student machine learning model with the outputs of the teacher machine learning model with outputs of the student machine learning model (at a present training step) to determine a retrospective knowledge distillation loss. For instance, the retrospective distillation learning system retrieves (or identifies) past-state outputs of the student machine learning model from a previous training time step. Moreover, the retrospective distillation learning system combines the past-state outputs of the student machine learning model with the outputs of the teacher machine learning model to determine a combined student-regularized teacher outputs that regularizes training targets by making the training targets similar to the student outputs while preserving semantics from the teacher training targets. Indeed, in some instances, the retrospective distillation learning system determines a retrospective knowledge distillation loss using a comparison of the outputs of the student machine learning model (from the present training step) and the combined student-regularized teacher output. In turn, the retrospective distillation learning system (during the present training step) learns parameters of the student machine learning model from the retrospective knowledge distillation loss.

In some embodiments, the retrospective knowledge distillation learning system periodically updates the model state (e.g., via a time step selection) to utilize an updated past-state output of the student machine learning model to increase training target difficulty while training the student machine learning model using a retrospective knowledge distillation loss. For example, the retrospective distillation learning system updates the time step used to obtain past-state outputs from the student machine learning model during training of the student machine learning model. In some cases, the retrospective knowledge distillation learning system selects the updated time step based on a checkpoint-update frequency value. Indeed, in one or more embodiments, the retrospective knowledge distillation learning system utilizes the updated time step to retrieve an additional past-state output corresponding to the updated time step and then determines an updated combined student-regularized teacher output using the additional past-state output. Furthermore, in one or more cases, the retrospective knowledge distillation learning system utilizes the updated combined student-regularized teacher output to determine a retrospective knowledge distillation loss for training the student machine learning model.

As mentioned above, conventional systems suffer from a number of technical deficiencies. For example, during the training of student machine learning models from well-trained teacher networks having high performance on tasks, many conventional systems suffer from the teacher networks becoming too complex and the smaller student network becoming unable to absorb knowledge from the teacher network. Additionally, oftentimes, conventional systems are unable to add information to the student network due to the class outputs of teacher networks being zero class probabilities (e.g., having very high probabilities for a correct class and almost zero class probabilities for other classes). In many instances, this capacity difference between a teacher network and a student network is referred to as a knowledge gap and, on conventional systems, such a knowledge gap results in inaccurate learning on a student network.

In order to mitigate the knowledge gap issue, some conventional systems retrain the teacher machine learning model while optimizing the student machine learning model. In one or more instances, conventional systems also leverage knowledge distillation losses from checkpoints of different time-steps of teacher training (which requires saving weights of teacher models at different training checkpoints) in an attempt to lessen the knowledge gap problem. Additionally, some instances, conventional systems utilize intermediate models to train a student network to regularize the student model.

These approaches taken by conventional systems, however, often are computationally inefficient. For instance, in many cases, retraining a teacher machine learning model, using checkpoints from teacher training models, and/or utilizing intermediate training models on the student machine learning models require significant resources and/or time overhead during training. In addition to efficiency, the above-mentioned approaches of conventional systems often are inflexible. For instance, conventional systems that utilize the above-mentioned approaches often require access to a teacher network (e.g., architecture, snapshots, retraining of teacher models) and are unable to train a student network with only converged outputs of teacher machine learning models. Accordingly, conventional systems are unable to mitigate knowledge gaps between student and teacher networks while training student networks without computationally inefficient approaches and/or without excessive access to the teacher network.

The retrospective knowledge distillation learning system provides a number of advantages relative to these conventional systems. For example, in contrast to conventional systems that often utilize inefficient computational resources and/or time through access of the teacher machine learning model and/or utilizing intermediate training models, the retrospective knowledge distillation learning system efficiently reduces the knowledge gap during teacher-to-student network distillation. For example, the retrospective knowledge distillation learning system reduces the knowledge gap during the teacher-to-student network distillation process while efficiently utilizing past student machine learning model states instead of computationally expensive intermediate models and/or deep access into teacher machine learning models. Accordingly, in one or more cases, the retrospective knowledge distillation learning system improves the accuracy of knowledge distillation while reducing the utilization of intermediate training models or excessively training and/or modifying the teacher network during knowledge distillation.

Indeed, in one or more embodiments, the retrospective knowledge distillation learning system increases the accuracy of knowledge distillation from a teacher network to a student network by efficiently leveraging past student outputs to ease the complexity of the training targets from the teacher network by making the training target from the teacher network relatively similar to the student outputs while preserving the semantics from the teacher network targets. For instance, by combining the teacher network targets with knowledge from past states of the student network, the retrospective knowledge distillation learning system sets the difficulty of the teacher network targets to be less difficult than the teacher network targets outright and more difficult than the past student network state.

In addition to efficiently improving accuracy, in some embodiments, the retrospective knowledge distillation learning system also increases flexibility during teacher-to-student network knowledge distillation. For instance, unlike conventional systems that require intermediate models and/or access into a teacher network to perform knowledge distillation, the retrospective distillation learning system utilizes internally available student network states and already-converged teacher network outputs. In particular, in one or more embodiments, the retrospective distillation learning system increases the accuracy of knowledge distillation and is easier to scale for a huge span of real-world applications because computationally expensive intermediate learning models are not utilized during training of the student network. Moreover, in one or more instances, the retrospective distillation learning system enables knowledge distillation from a wider range of teacher networks because access to past states (or other internal data) of the teacher network and/or retraining of the teacher network is not necessary to benefit from the knowledge gap reduction caused utilizing the retrospective knowledge loss.

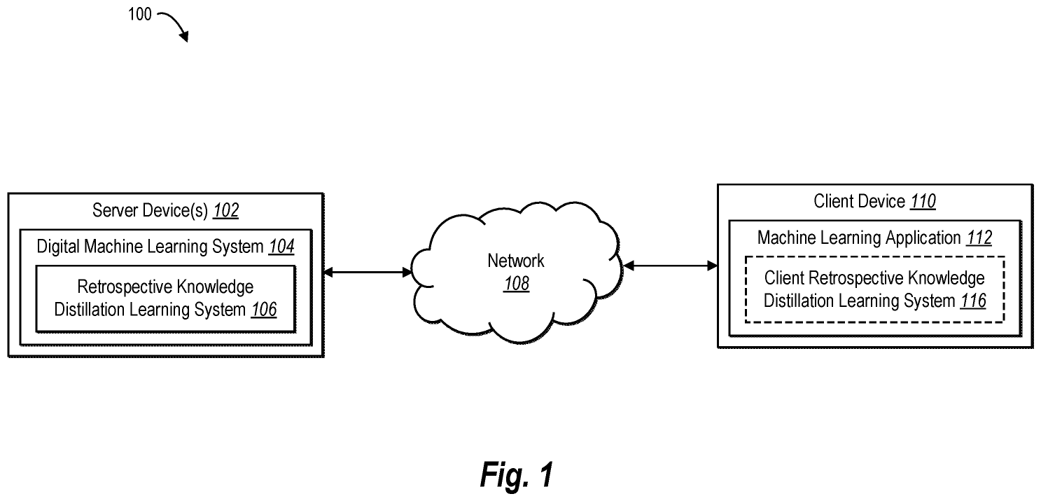

Turning now to the figures, FIG. 1 illustrates a schematic diagram of one or more implementations of a system 100 (or environment) in which a retrospective distillation learning system operates in accordance with one or more implementations. As illustrated in FIG. 1, the system 100 includes server device(s) 102, a network 108, and a client device 110. As further illustrated in FIG. 1, the server device(s) 102 and the client device 110 communicate via the network 108.

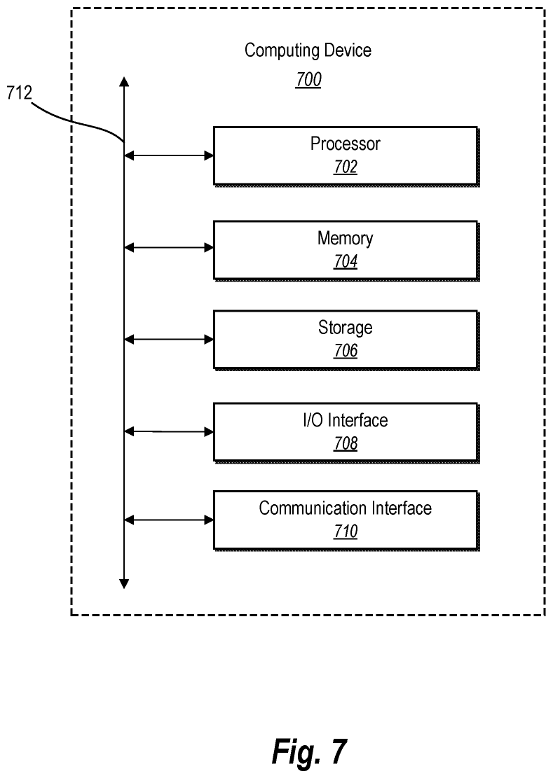

In one or more implementations, the server device(s) 102 includes, but is not limited to, a computing (or computer) device (as explained below with reference to FIG. 7). As shown in FIG. 1, the server device(s) 102 include a digital machine learning system 104 which further includes the retrospective knowledge distillation learning system 106. The digital machine learning system 104 can generate, train, store, deploy, and/or utilize various machine learning models for various machine learning applications, such as, but not limited to, image tasks, video tasks, classification tasks, text recognition tasks, voice recognition tasks, artificial intelligence tasks, and/or digital analytics tasks.

Moreover, as explained below, the retrospective knowledge distillation learning system 106, in one or more embodiments, leverages past state outputs of a student machine learning model (from historical time steps) to determine a retrospective knowledge distillation loss during teacher-to-student network knowledge distillation to train the student machine learning model. In some implementations, the retrospective knowledge distillation learning system 106 determines combined student-regularized teacher output logits from output logits of a teacher machine learning model and past-state outputs of a student machine learning model. Then, the retrospective knowledge distillation learning system 106 compares the combined student-regularized teacher output logits to output logits of the student machine learning model (in a current state) to determine a retrospective knowledge distillation loss. Indeed, in one or more embodiments, the retrospective knowledge distillation learning system 106 utilizes the retrospective knowledge distillation loss to train the student machine learning model (e.g., as a compact version of the teacher machine learning model).

Furthermore, as shown in FIG. 1, the system 100 includes the client device 110. In one or more implementations, the client device 110 includes, but is not limited to, a mobile device (e.g., smartphone, tablet), a laptop, a desktop, or any other type of computing device, including those explained below with reference to FIG. 7. In certain implementations, although not shown in FIG. 1, the client device 110 is operated by a user to perform a variety of functions (e.g., via the machine learning application 112). For example, the client device 110 performs functions such as, but not limited to, utilizing a machine learning model (e.g., locally or via the server device(s) 102) during the capture of and/or editing of digital images and/or videos, playing digital images and/or videos, during text recognition tasks, during voice recognition tasks, and/or during the utilization of digital analytics tools on the client device 110.

To access the functionalities of the retrospective knowledge distillation learning system 106 (as described above), in one or more implementations, a user interacts with the machine learning application 112 on the client device 110. For example, the machine learning application 112 includes one or more software applications installed on the client device 110 (e.g., to utilize machine learning models in accordance with one or more implementations herein). In some cases, the machine learning application 112 is hosted on the server device(s) 102. In addition, when hosted on the server device(s), the machine learning application 112 is accessed by the client device 110 through a web browser and/or another online interfacing platform and/or tool.

Although FIG. 1 illustrates the retrospective knowledge distillation learning system 106 being implemented by a particular component and/or device within the system 100 (e.g., the server device(s) 102), in some implementations, the retrospective knowledge distillation learning system 106 is implemented, in whole or in part, by other computing devices and/or components in the system 100. For example, in some implementations, the retrospective knowledge distillation learning system 106 is implemented on the client device 110 within the machine learning application 112 (e.g., via a client retrospective knowledge distillation learning system 116). Indeed, in one or more implementations, the description of (and acts performed by) the retrospective knowledge distillation learning system 106 are implemented (or performed by) the client retrospective knowledge distillation learning system 116 when the client device 110 implements the retrospective knowledge distillation learning system 106. More specifically, in some instances, the client device 110 (via an implementation of the retrospective knowledge distillation learning system 106 on the client retrospective knowledge distillation learning system 116) leverages past state outputs of a student machine learning model to determine a retrospective knowledge distillation loss during teacher-to-student network knowledge distillation to train the student machine learning model.

In some implementations, both the server device(s) 102 and the client device 110 implement various components of the retrospective knowledge distillation learning system 106. For instance, in some embodiments, the server device(s) 102 (via the retrospective knowledge distillation learning system 106) compresses, miniaturizes, and transfers the model parameters of a deeper and wider deep teacher machine learning model to generate a compact student machine learning model via retrospective knowledge distillation losses (as described herein). In addition, in some instances, the server device(s) 102 deploy the compressed student machine learning model to the client device 110 to implement/apply the student machine learning model (for its trained task) on the client device 110. Indeed, in many cases, the retrospective knowledge distillation learning system 106 trains a compact student machine learning model in accordance with one or more implementations herein to result in a machine learning model that fits and operates on the client device 110 (e.g., a mobile device, an electronic tablet, a personal computer). For example, the client device 110 utilizes the student machine learning model (trained for a specific application or task) for various machine learning applications, such as, but not limited to, image tasks, video tasks, classification tasks, text recognition tasks, voice recognition tasks, artificial intelligence tasks, and/or digital analytics tasks.

Additionally, as shown in FIG. 1, the system 100 includes the network 108. As mentioned above, in some instances, the network 108 enables communication between components of the system 100. In certain implementations, the network 108 includes a suitable network and may communicate using any communication platforms and technologies suitable for transporting data and/or communication signals, examples of which are described with reference to FIG. 7. Furthermore, although FIG. 1 illustrates the server device(s) 102 and the client device 110 communicating via the network 108, in certain implementations, the various components of the system 100 communicate and/or interact via other methods (e.g., the server device(s) 102 and the client device 110 communicating directly).

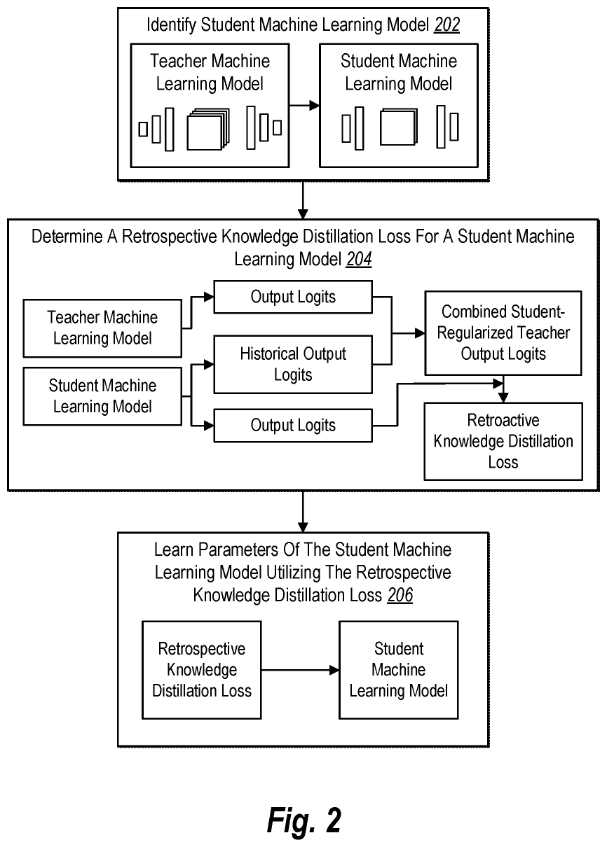

As previously mentioned, in one or more implementations, the retrospective knowledge distillation learning system 106 leverages past state outputs of a student machine learning model to determine a retrospective knowledge distillation loss during teacher-to-student network knowledge distillation to train the student machine learning model. For example, FIG. 2 illustrates an overview of the retrospective knowledge distillation learning system 106 determining a retrospective knowledge distillation loss and utilizing the retrospective knowledge distillation loss to train a student machine learning model. As shown in FIG. 2, the retrospective knowledge distillation learning system 106 identifies a student machine learning model for a teacher machine learning model, identifies outputs of the student machine learning model, and identifies outputs of the teacher machine learning model to determine a retrospective knowledge distillation loss during a training phase. In addition, FIG. 2 also illustrates the retrospective knowledge distillation learning system 106 training the student machine learning model with the retrospective knowledge distillation loss.

As shown in act 202 of FIG. 2, the retrospective knowledge distillation learning system 106 identifies a student machine learning model. In some cases, the retrospective knowledge distillation learning system 106 identifies, from a larger machine learning model, a smaller version of the machine learning model as a student machine learning model. In some cases, the retrospective knowledge distillation learning system 106 prunes, condenses, or reduces layers (or other components) of a machine learning model to generate a smaller machine learning model (as the student machine learning model). In some implementations, the retrospective knowledge distillation learning system 106 receives a student machine learning model that corresponds to a teacher machine learning model (e.g., a pruned machine learning model, a compressed machine learning model).

In one or more embodiments, a machine learning model can include a model that can be tuned (e.g., trained) based on training input to approximate unknown functions. In particular, in some instances, a machine learning model includes a model of interconnected digital layers, neurons, and/or nodes that communicate and learn to approximate complex functions and generate outputs based on one or more inputs provided to the model. For instance, a machine learning model includes one or more machine learning algorithms. In some implementations, a machine learning model includes deep convolutional neural networks (i.e., “CNNs”) and fully convolutional neural networks (i.e., “FCNs”), residual neural networks (i.e., “ResNet”), recurrent neural network (i.e., “RNN”), and/or generative adversarial neural network (i.e., “GAN”). In some cases, a machine learning model is an algorithm that implements deep learning techniques, i.e., machine learning that utilizes a set of algorithms to attempt to model high-level abstractions in data.

In some embodiments, a teacher machine learning model (sometimes referred to as a “teacher network”) includes a target machine learning model that is utilized to train (or transfer knowledge to) a smaller, lighter, and/or less complex machine learning model. Indeed, in some instances, a student machine learning model (sometimes referred to as a “student network”) includes a machine learning model that is reduced, condensed, pruned, or miniaturized from a more complex (or larger) teacher machine learning model through a transfer of knowledge and/or training to mimic the more complex (or larger) teacher machine learning model.

As further shown in act 204 of FIG. 2, the retrospective knowledge distillation learning system 106 determines a retrospective knowledge distillation loss for a student machine learning model. For example, as shown in the act 204 of FIG. 2, the retrospective knowledge distillation learning system 106 identifies output logits from the teacher machine learning model. Additionally, as shown in the act 204 of FIG. 2, the retrospective knowledge distillation learning system 106 identifies historical output logits from the student machine learning model (e.g., specific to a past state of the student machine learning model).

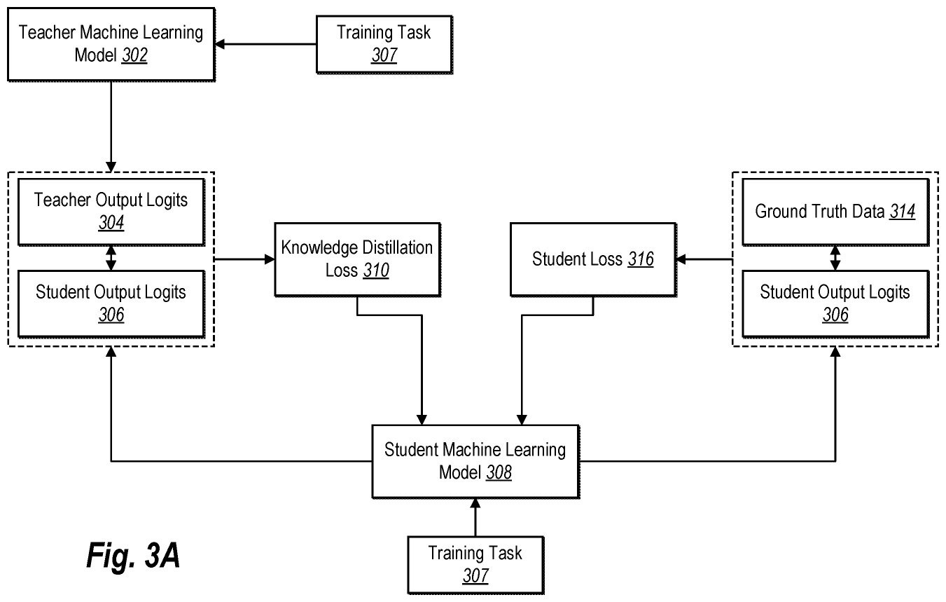

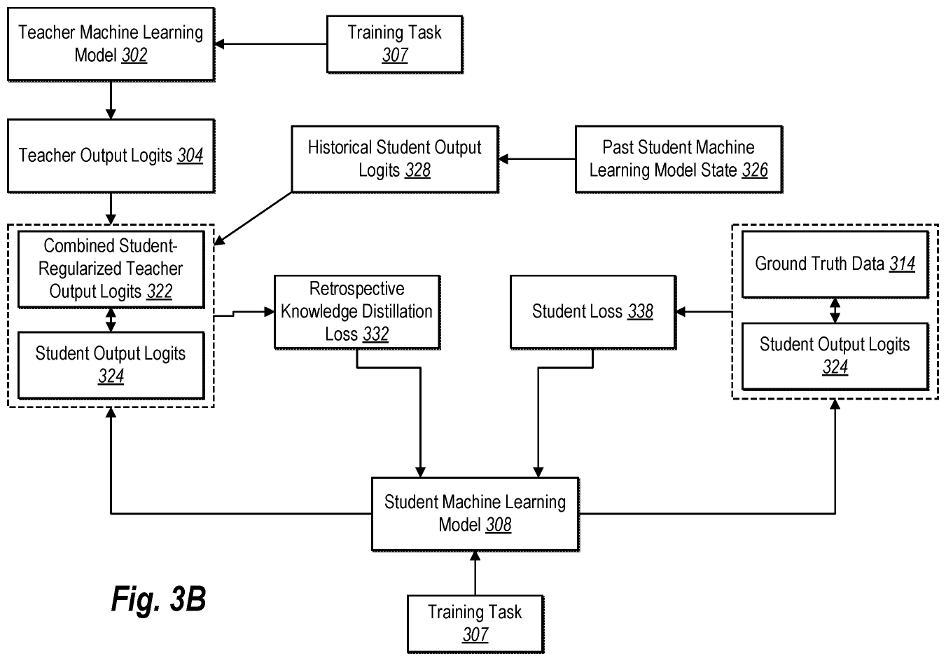

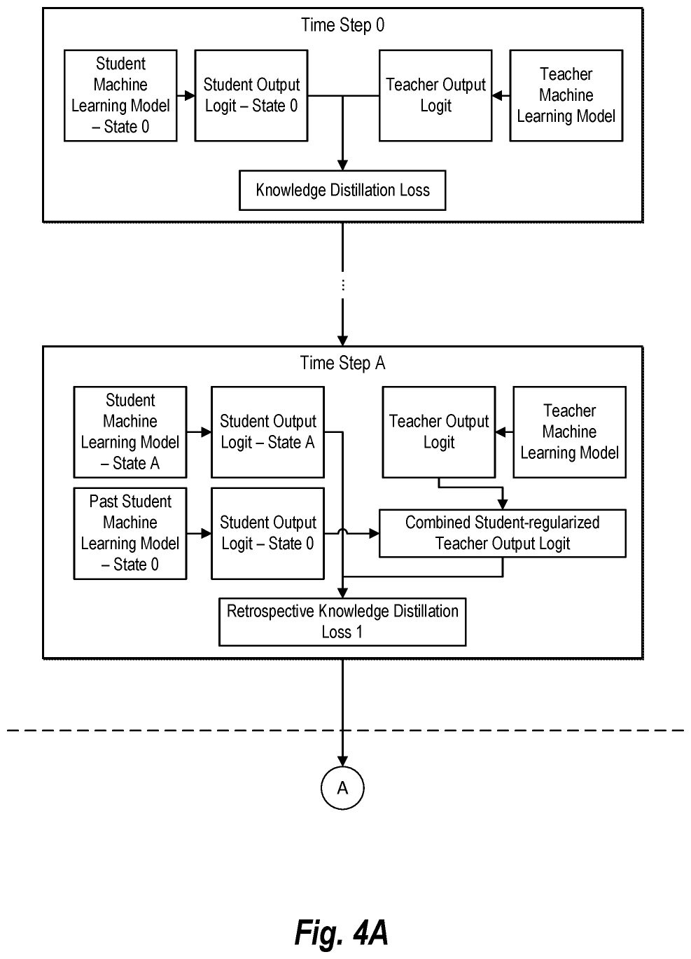

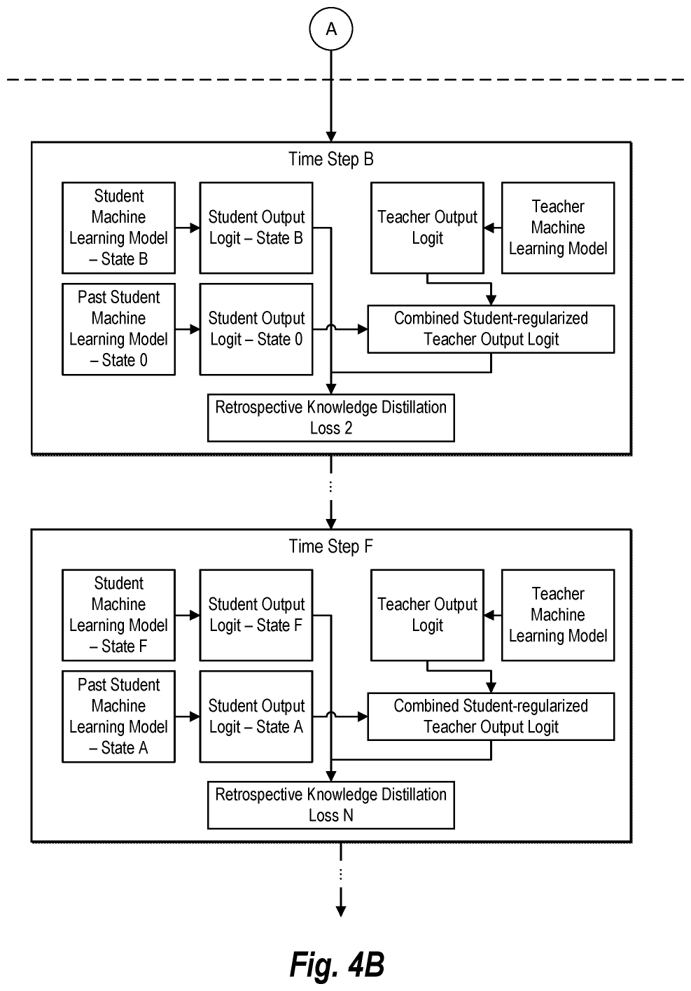

In addition, as shown in the act 204 of FIG. 2, the retrospective knowledge distillation learning system 106 utilizes the output logits from the teacher machine learning model and historical output logits from the student machine learning model (e.g., from a historical time step) to determine combined student-regularized teacher output logits. In addition, as shown in the act 204, the retrospective knowledge distillation learning system 106 compares the combined student-regularized teacher output logits with output logits of the student machine learning model to determine a retrospective knowledge distillation loss. In one or more embodiments, in the act 204, the retrospective knowledge distillation learning system 106 utilizes historical output logits from past states of the student machine learning model and utilizes the output logits of the student machine learning model from a current training state the student machine learning model. Indeed, in one or more implementations, the retrospective knowledge distillation learning system 106 determines a retrospective knowledge distillation loss as described below (e.g., as described in relation to FIGS. 3A-3B and 4A-4B).

In one or more embodiments, a machine learning model output (sometimes referred to as “output logits”) include prediction and/or result values determined by machine learning models in response to an input task. In some cases, output logits include one or more values that indicate one or more determinations, such as, but not limited to, label classifications, outcomes, results, scores, and/or solutions from a machine learning model. As an example, output logits include determinations, such as, but not limited to, probability values for one or more classifications provided by a machine learning model and/or matrices indicating one or more predictions and/or outcomes from the machine learning model.

In some cases, an input task (sometimes referred to as a training task or input) includes data provided and analyzed by a machine learning model to predict a classification and/or outcome (e.g., via output logits). For example, an input task includes a data, such as, but not limited to, a digital image, a digital video, text, a voice recording, a spreadsheet, and/or a data table. In some embodiments, an input task includes corresponding ground truth data that indicates a known or desired prediction, label, or outcome for the input task (e.g., a specific classification for a training image, a specific transcript for a voice recording).

In one or more implementations, combined student-regularized teacher output logits include a teacher machine learning model target that is regularized using historical student network output logits. In particular, in one or more embodiments, combined student-regularized teacher output logits include knowledge from a historical state of a student machine learning model while including certain knowledge from the teacher machine learning model to be more difficult of a training target than the past state of the student machine learning model while being less difficult of a training target than the teacher machine learning model.

As further shown in act 206 of FIG. 2, the retrospective knowledge distillation learning system 106 learns parameters of the student machine learning model utilizing the retrospective knowledge distillation loss. In particular, in one or more embodiments, the retrospective knowledge distillation learning system 106 utilizes the retrospective knowledge distillation loss as an indicator of accuracy of the student machine learning model and adjusts parameters of the student machine learning model to correct the accuracy. In some cases, the parameters of a student machine learning model include data, such as, but not limited to one or more weights and/or one or more hyperparameters of the machine learning model (e.g., model coefficients, depth parameters, variance errors, bias errors, perceptron classifiers, regression classifiers, nearest neighbor classifiers). Indeed, in one or more cases, the retrospective knowledge distillation learning system 106 modifies the parameters of the student machine learning model to account for (and modify) the incorrect (or correct) behavior indicated by the retrospective knowledge distillation loss (and one or more other loss functions) (e.g., using back propagation).

As mentioned above, in one or more embodiments, the retrospective knowledge distillation learning system 106 regularizes learning targets of a student machine learning model by leveraging past state outputs of the student machine learning model with outputs of a teacher machine learning model to determine a retrospective knowledge distillation loss for teacher-to-student network knowledge distillation. In one or more implementations, the retrospective knowledge distillation learning system 106 utilizes a knowledge distillation loss during a training warmup phase (e.g., for a number of time steps) and a retrospective knowledge distillation loss after the training warmup phase. Indeed, FIGS. 3A and 3B illustrate the retrospective knowledge distillation learning system 106 utilizing both a knowledge distillation loss and a retrospective knowledge distillation loss during teacher-to-student network knowledge distillation.

For example, FIG. 3A illustrates the retrospective knowledge distillation learning system 106 learning parameters of a student machine learning model utilizing a knowledge distillation loss during a training warmup phase. As shown in FIG. 3A, the retrospective knowledge distillation learning system 106 obtains teacher output logits 304 from a teacher machine learning model 302 that corresponds to a training task 307. In addition, as shown in FIG. 3A, the retrospective knowledge distillation learning system 106 utilizes the training task 307 with the student machine learning model 308 to obtain student output logits 306. As further illustrated in FIG. 3A, the retrospective knowledge distillation learning system 106 compares the teacher output logits 304 to the student output logits 306 to determine a knowledge distillation loss 310. As further shown in FIG. 3A, the retrospective knowledge distillation learning system 106 utilizes the knowledge distillation loss 310 with the student machine learning model 308 (e.g., to adjust or learn parameters of the student machine learning model 308).

Additionally, as shown in FIG. 3A, the retrospective knowledge distillation learning system 106 utilizes the student output logits 306 with ground truth data 314 to determine a student loss 316. In particular, the retrospective knowledge distillation learning system 106 compares the student output logits 306 to the ground truth data 314 associated with the training task 307 to determine a loss (e.g., via a loss function). As further shown in FIG. 3A, the retrospective knowledge distillation learning system 106 utilizes the student loss 316 with the student machine learning model 308 (e.g., to adjust or learn parameters of the student machine learning model 308). In some cases, the retrospective knowledge distillation learning system 106 utilizes a combination of the knowledge distillation loss 310 and the student loss 316 to learn parameters of the student machine learning model 308.

In one or more implementations, the retrospective knowledge distillation learning system 106 matches outputs logits of a student machine learning network to a ground truth label of the training task (e.g., input training data) to determine a student loss (e.g., student loss 316). For instance, the retrospective knowledge distillation learning system 106 utilizes a loss function with the ground truth label of the training task and the outputs logits of the student machine learning network to determine the student loss. As an example, the retrospective knowledge distillation learning system 106 utilizes output logits of a network z (e.g., a student network) with a ground truth label ŷ to determine a Cross-Entropy loss [symbol] _{CE} using a Cross-Entropy loss function as described in the following function:

[symbol]

_{CE}=H(softmax(z),\hat{y}) (1)

In the above-mentioned function (1), the retrospective knowledge distillation learning system 106 utilizes a softmax function to normalize the output logit. In some cases, the retrospective knowledge distillation learning system 106 determines a student loss without utilizing a softmax function. Furthermore, although one or more embodiments describe the retrospective knowledge distillation learning system 106 utilizing a Cross-Entropy loss, the retrospective knowledge distillation learning system 106 utilizes various loss functions, such as, but not limited to, gradient penalty loss, mean square error, regression loss function, and/or hinge loss.

Furthermore, in one or more embodiments, the retrospective knowledge distillation learning system 106 utilizes knowledge distillation via a knowledge distillation loss to transfer knowledge from one neural network to another (e.g., from a larger teacher network to a smaller student network). As illustrated in FIG. 3A, the retrospective knowledge distillation learning system 106 utilizes teacher machine learning output logits and student machine learning output logits to determine a knowledge distillation loss. For example, knowledge distillation is utilized by the retrospective knowledge distillation learning system 106 to train a smaller student network with the outputs of a larger pre-trained teacher network. In some cases, the retrospective knowledge distillation learning system 106 utilizes the teacher outputs as information in terms of class correlations and uncertainties to force a student network to mimic the class correlations and uncertainties.

To illustrate, in some cases, the retrospective knowledge distillation learning system 106, for a given input training task x, determines student output logits zₛ=ƒₛ(x) and teacher output logits zₜ=ƒₜ(x). In some instances, the retrospective knowledge distillation learning system 106 further softens (or normalizes) the output logits through temperature parameters τ and softmax functions to obtain softened student output logits yₛ and softened teacher output logits yₜ as described in the following function:

yₛ=softmax(zₛ/τ),yₜ=softmax(zₜ/τ) (2)

Moreover, in one or more implementations, the retrospective knowledge distillation learning system 106 determines a knowledge distillation loss from the student output logits yₛ and teacher output logits yₜ. For instance, in some cases, the retrospective knowledge distillation learning system 106 utilizes the student output logits yₛ and teacher output logits yₜ to determine a knowledge distillation loss [symbol] _{KD} using the following function:

[symbol]

_{KD}=τ²KL(yₛ,yₜ) (3)

In the above-mentioned function (3), the retrospective knowledge distillation learning system 106 utilizes a Kullback-Leibler Divergence (KL). However, in one or more embodiments, the retrospective knowledge distillation learning system 106 utilizes various types of knowledge distillation functions, such as, but not limited to norm-based knowledge distillation losses, perceptual knowledge distillation losses.

Indeed, in some implementations, the retrospective knowledge distillation learning system 106 utilizes the student loss and the knowledge distillation loss as a combined training objective (e.g., a combined training loss) utilized to learn parameters of the student network. For example, the retrospective knowledge distillation learning system 106 utilizes a combined training objective [symbol] using the following function:

[symbol]

=α [symbol] _{KD}+(1−α) [symbol] _{CE} (4)

In the above-mentioned function (4), the retrospective knowledge distillation learning system 106 utilizes a weight balancing parameter α to combine the individual training objectives.

As previously mentioned, after the training warmup phase, in one or more implementations, the retrospective knowledge distillation learning system 106 utilizes a combination of historical outputs of the student machine learning model with the outputs of the teacher machine learning model with outputs of the student machine learning model (at a present training step) to determine a retrospective knowledge distillation loss. For example, FIG. 3B illustrates the retrospective knowledge distillation learning system 106 learning parameters of the student machine learning model utilizing a retrospective knowledge distillation loss after a training warmup phase. Indeed, as shown in FIG. 3B, the retrospective knowledge distillation learning system 106 obtains historical student output logits 328 from past student machine learning model state 326. As further shown in FIG. 3B, the retrospective knowledge distillation learning system 106 utilizes the historical student output logits 328 with the teacher output logits 304 from the teacher machine learning model 302 (corresponding to the training task 307) to determine combined student-regularized teacher output logits 322.

Moreover, as shown in FIG. 3B, the retrospective knowledge distillation learning system 106 utilizes the training task 307 with the student machine learning model 308 (e.g., in a new training step or state) to obtain student output logits 324. As further illustrated in FIG. 3B, the retrospective knowledge distillation learning system 106 compares the student output logits 324 to the combined student-regularized teacher output logits 322 to determine a retrospective knowledge distillation loss 332. Then, as shown in FIG. 3B, the retrospective knowledge distillation learning system 106 utilizes the retrospective knowledge distillation loss 332 with the student machine learning model 308 (e.g., to adjust or learn parameters of the student machine learning model 308).

Additionally, as shown in FIG. 3B, the retrospective knowledge distillation learning system 106 utilizes the student output logits 324 with the ground truth data 314 to determine a student loss 338. In particular, the retrospective knowledge distillation learning system 106 compares the student output logits 324 to the ground truth data 314 associated with the training task 307 to determine a loss (e.g., via a loss function as described above). As further shown in FIG. 3B, the retrospective knowledge distillation learning system 106 utilizes the student loss 338 with the student machine learning model 308 (e.g., to adjust or learn parameters of the student machine learning model 308). In some cases, the retrospective knowledge distillation learning system 106 utilizes a combination of the retrospective knowledge distillation loss 332 and the student loss 338 to learn parameters of the student machine learning model 308.

As mentioned above, the retrospective knowledge distillation learning system 106 utilizes a retrospective knowledge distillation loss through a combined student-regularized teacher outputs that regularizes training targets by making the training targets similar to the student outputs while preserving semantics from the teacher training targets. For example, for a given input training task x, the retrospective knowledge distillation learning system 106 determines student output logits zₛ^{T}∈R^{C} for a time step T (in which R is a set of real numbers and C is a number of classes) from a student network ƒₛ parameterized by θₛ^{T}. In addition, in one or more implementations, for the given input training task x, the retrospective knowledge distillation learning system 106 also determines teacher output logits zₜ∈R^{C} from a teacher network ƒₜ parameterized by θₜ. Indeed, in one or more instances, the retrospective knowledge distillation learning system 106 determines student output logits zₛ^{T} for the time step T and teacher output logits zₜ as described in the following function:

zₛ^{T}=ƒₛ(x;θₛ^{T}),zₜ=ƒₜ(x;θₜ) (5)

In addition, in one or more embodiments, the retrospective knowledge distillation learning system 106 determines past-state student output logits. For instance, the retrospective knowledge distillation learning system 106 identifies a past state of a student network ƒₛ at a previous time step Tₚₐₛₜ which occurs prior to the current time step T (e.g., Tₚₐₛₜ<T). Then, in one or more instances, the retrospective knowledge distillation learning system 106 determines past-state student output logits zₛ^{T}^{ₚₐₛₜ} for the input training task x from a past state of a student network as described in the following function:

zₛ^{T}^{ₚₐₛₜ}=ƒₛ(x;θₛ^{T}^{ₚₐₛₜ}) (6)

Furthermore, in one or more implementations, the retrospective knowledge distillation learning system 106 utilizes the teacher output logits and past-state student output logits to determine combined student-regularized teacher output logits. In some instances, the retrospective knowledge distillation learning system 106 utilizes an output composition function (i.e., OCF, O_{c}) to combine the teacher output logits and past-state student output logits and obtain the combined student-regularized teacher output logits. For example, the retrospective knowledge distillation learning system 106 determines combined student-regularized teacher output logits z_{t,reg} with an output composition function O_{c} from past-state student output logits zₛ^{T}^{ₚₐₛₜ} and teacher output logits zₜ as described in the following function:

z_{t,reg}=O_{c}(zₜ,zₛ^{T}^{ₚₐₛₜ};λ) (7)

In the above-mentioned function (7), the retrospective knowledge distillation learning system 106 utilizes a hyper-parameter λ that is self-adjusting and/or determined from input provided via a client (or an administrator) device.

In certain instances, the retrospective knowledge distillation learning system 106 utilizes interpolation as the output composition function to determine the combined student-regularized teacher output logits. For example, the retrospective knowledge distillation learning system 106 utilizes the output composition function as an interpolation operation as described in the following function:

O_{c}(a,b;λ)=λa+(1−λ)b (8)

More specifically, the retrospective knowledge distillation learning system 106 utilizes interpolation between the past-state student output logits zₛ^{T}^{ₚₐₛₜ} and the teacher output logits zₜ to obtain combined student-regularized teacher output logits z_{t,reg} t for the input training task x utilizing an interpolating factor λ as described in the following function:

z_{t,reg}(x)=λzₛ^{T}^{ₚₐₛₜ}(x)+(1−λ)zₜ(x) (9)

Although one or more embodiments describe the retrospective knowledge distillation learning system 106 utilizing linear interpolation as the output composition function to determine the combined student-regularized teacher output logits, the retrospective knowledge distillation learning system 106, in some cases, utilizes various output composition functions, such as, but not limited to, inverse distance weighted interpolation, spline interpolation, multiplication, and/or averaging.

Furthermore, as mentioned above, the retrospective knowledge distillation learning system 106, in one or more embodiments, utilizes a knowledge distillation loss in a training warmup phase and a retrospective distillation loss after a training warmup phase T_{warmup} to train a student machine learning model. In some instances, the retrospective knowledge distillation learning system 106 a resulting teacher supervision target aₜ based on the time step T (as a selection between teacher output logits zₜ or combined student-regularized teacher output logits z_{t,reg} as described in the following function:

$${a}_{t} = \{ \begin{matrix}{z}_{t} & T < {T}_{warmup} \\ {z}_{t , reg} & otherwise\end{matrix} \qquad ( 10 )$$

In some implementations, the retrospective knowledge distillation learning system 106 utilizes a training loss objective to learn parameters of the student machine learning model that utilizes both a student loss (as described above) and a knowledge distillation loss based on a teacher supervision target that results in a retrospective knowledge distillation loss (e.g., after a training warmup phase). For instance, the retrospective knowledge distillation learning system 106 utilizes the ground truth label ŷ and a loss balancing parameter α between two or more loss terms to determine a training loss objective for the student machine learning model. To illustrate, in some cases, the retrospective knowledge distillation learning system 106 determines a loss training objective [symbol] that utilizes a teacher supervision target aₜ (as described in function (10)) and a student loss (as described in function (1)) as described by the following function:

$$ℒ = {αℒ}_{KD} ( \frac{{z}_{s}^{T}}{τ} , \frac{{a}_{t}}{τ} ) + ( 1 - α ) {ℒ}_{CE} ( {z}_{s}^{T} , \hat{y} ) \qquad ( 11 )$$

For example, as described above, the retrospective knowledge distillation learning system 106 utilizes the above-mentioned loss training objective from function (11) to learn parameters of the student machine learning model.

As previously mentioned, in some instances, the retrospective knowledge distillation learning system 106 periodically updates the model state (e.g., via a time step selection) to utilize an updated past-state output of the student machine learning model to increase training target difficulty while training the student machine learning model using a retrospective knowledge distillation loss. In particular, in one or more embodiments, after a certain number of iterations, the retrospective knowledge distillation learning system 106 determines that the student machine learning model is outgrowing the past knowledge of the student machine learning model (e.g., is considered to be better than the past state of the machine learning model at a particular past-time step). Accordingly, in one or more embodiments, the retrospective knowledge distillation learning system 106 updates the past state to a more recent past state to advance the relative hardness of training targets.

For example, FIGS. 4A and 4B illustrate the retrospective knowledge distillation learning system 106 periodically updating the model state (e.g., via a time step selection) to utilize as an updated past-state output of the student machine learning model while training the student machine learning model using a retrospective knowledge distillation loss. As shown in FIG. 4A, during a time step 0 (e.g., an initial time step that is part of a training warmup phase), the retrospective knowledge distillation learning system 106 utilizes student output logits from a State 0 (of a State 0 student machine learning model) with teacher output logits from the teacher machine learning model to determine a knowledge distillation loss (e.g., utilized to iteratively learn parameters of the student machine learning model at State 0).

Then, as shown in FIG. 4A, at a future state (time step A), the retrospective knowledge distillation learning system 106 utilizes the student output logits from the past student machine learning model at State 0 as past-state student output logits (of State 0). Indeed, as shown in FIG. 4A, the retrospective knowledge distillation learning system 106 under time step A, utilizes the teacher output logits with the past-state student output logits (of State 0) to determine combined student-regularized teacher output logits. Subsequently, as further shown in time step A of FIG. 4A, the retrospective knowledge distillation learning system 106 utilizes the combined student-regularized teacher output logits and the student output logits from the current state (e.g., State A) to determine a retrospective knowledge distillation loss 1 (e.g., utilized to iteratively learn parameters of the student machine learning model at State A).

As further shown in the transition from FIG. 4A to FIG. 4B, the retrospective knowledge distillation learning system 106, at a subsequent or future state (time step B), further utilizes the student output logits from the past student machine learning model at State 0 as past-state student output logits (of State 0). In particular, as shown in time step B of FIG. 4B, the retrospective knowledge distillation learning system 106 determines combined student-regularized teacher output logits from the teacher output logits of the teacher machine learning model with the past-state student output logits (of State 0). As further shown in time step B of FIG. 4B, the retrospective knowledge distillation learning system 106 utilizes the combined student-regularized teacher output logits and the student output logits from the current state (e.g., State B) to determine a retrospective knowledge distillation loss 2 (e.g., utilized to iteratively learn parameters of the student machine learning model at State B).

Moreover, FIG. 4B at time step F illustrates the retrospective knowledge distillation learning system 106 updating the model state to utilize an updated past-state output of the student machine learning model while training the student machine learning model using a retrospective knowledge distillation loss. For example, as shown at time step F of FIG. 4B, the retrospective knowledge distillation learning system 106 utilizes the student output logits from the past student machine learning model at State A (instead of State 0) as updated past-state student output logits (from State A). As further shown in FIG. 4B, the retrospective knowledge distillation learning system 106 under time step F, utilizes the teacher output logits with the updated past-state student output logits (of State A) to determine updated combined student-regularized teacher output logits. Then, as shown in time step F in FIG. 4B, the retrospective knowledge distillation learning system 106 utilizes the updated combined student-regularized teacher output logits and the student output logits from the current state (e.g., State A) to determine a retrospective knowledge distillation loss N (e.g., utilized to iteratively learn parameters of the student machine learning model at State F). Indeed, as shown in FIG. 4B, the retrospective knowledge distillation learning system 106 can continue to train the student machine learning model with a retrospective knowledge distillation loss based on one or more updated past states of the student machine learning model for various numbers of time steps.

In one or more embodiments, the retrospective knowledge distillation learning system 106 utilizes a checkpoint-update frequency value to update the past state of the student machine learning model utilized during a periodic update of for the combined student-regularized teacher output logits. Indeed, in some instances, the retrospective knowledge distillation learning system 106 utilizes the checkpoint-update frequency value to select a time step or past time step in which to utilize more recent past-state student output logits. For example, in some cases, the retrospective knowledge distillation learning system 106 utilizes a remainder function with a current time step (e.g., candidate time step) and the checkpoint-update frequency value to determine when to update the past time step using the current time step (e.g., when a current time step and the checkpoint-update frequency value result in a remainder of zero).

Although one or more embodiments, utilize a remainder to select an updated past time step (from a candidate time step), the retrospective knowledge distillation learning system 106, in one or more instances, utilizes various approaches to select the updated past time step, such as, but not limited to updating the past time step after a iterating through a checkpoint-update frequency value number of time steps and/or updating the past time step upon the current time step equaling a prime number.

In some cases, the retrospective knowledge distillation learning system 106 utilizes a threshold loss to update the past time step. For instance, the retrospective knowledge distillation learning system 106 determines that a retrospective knowledge distillation loss between the teacher output logits and past-state student output logits satisfies a threshold loss (e.g., retrospective knowledge distillation loss is equal to or is less than or equal to the threshold loss). Upon detecting that the retrospective knowledge distillation loss satisfies the threshold loss, the retrospective knowledge distillation learning system 106, in one or more implementations, updates the past time step using the current (candidate) time step (in which the threshold loss is satisfied).

In one or more embodiments, the retrospective knowledge distillation learning system 106 learns parameters of a student machine learning model utilizing a retrospective knowledge distillation loss (via a loss training objective [symbol] ) for current state student parameters θₛ^{T}, teacher parameters θₜ, a checkpoint-update frequency value ƒ_{update}, a number of warm-up iterations T_{warmup}, learning rate η, loss scaling parameter λ, and a number of training iterations N using the following Algorithm 1.

Algorithm 1
RetroKD Algorithm

```
θₛ^{T}^{ₚₐₛₜ} = NULL
for step T = 1 to N do
    Sample (x, y)ᵢ₌₁^{B}, from training data
    z_{s,i}^{T} = fₛ(xᵢ; θₛ^{T})
    z_{t,i} = fₜ(xᵢ; θₜ) [symbol]
      = [symbol] _{CE}(z_{s,i}^{T}, yᵢ)
    a_{t,i} = z_{t,i}
    if step > T_{warmup} then
        z_{s,i}^{T}^{ₚₐₛₜ} = fₛ(xᵢ; θₛ^{T}^{ₚₐₛₜ})
        z_{t,reg,i} = O_{c}(z_{t,}z_{s,i}^{T}^{ₚₐₛₜ}; λ)
        a_{t,i} = z_{t,reg,i}
    end if
    $ℒ = {αℒ}_{KD} ( \frac{{z}_{s , i}^{T}}{τ} , \frac{{a}_{t , i}}{τ} ) + ( 1 - α ) {ℒ}_{CE} ( {z}_{s , i}^{T} , {\hat{y}}_{i} )$
    θₛ^{T+1} ← θₛ^{T} − η∇ [symbol] _{θ}_{ₛ}_{^{T}}(xᵢ, yᵢ; θₛ^{T})
    if T % f_{update} = = 0 then
        θₛ^{T}^{ₚₐₛₜ} ← θₛ^{T}
    end if
end for
```

As mentioned above, the retrospective knowledge distillation learning system 106 efficiently and easily improves the accuracy of knowledge distillation from a teacher network to a student network utilizing a retrospective knowledge distillation loss (in accordance with one or more implementations herein). For example, experimenters utilized retrospective knowledge distillation on teacher networks in accordance with one or more implementations herein to compare results with other knowledge distillation techniques on teacher networks. In particular, the experimenters utilized various conventional knowledge distillation techniques on teacher networks to produce student networks and tested the student networks on various image datasets for accuracy. In addition, the experimenters also utilized retrospective knowledge distillation (using the retrospective knowledge distillation learning system 106 in accordance with one or more implementations herein) to produce student networks from the same teacher networks and tested the student network on various image datasets for accuracy.

For example, the experimenters utilized various networks as the teacher networks, including a CNN-4, CNN-8, CNN-10, ResNet-20, ResNet-32, and ResNet-56. Furthermore, the resulting student networks were tested for accuracy using the CIFAR-10, CIFAR-100, and TinyImageNet image datasets. As part of the experiment, the experimenters utilized Base Knowledge Distillation (BKD) and Distillation with Noisy Teacher (NT) as the conventional knowledge distillation techniques on teacher networks to produce student networks. Indeed, the experimenters used BKD as described in Hinton et. al., Distilling the Knowledge in a Neural Network, NIPS Deep Learning and Representation Learning Workshop, 2015. Furthermore, the experimenters used NT as described in Sau et. al., Deep Model Compression: Distilling Knowledge from Noisy Teachers, ArXiv Reprint ArXiv: 1610.09650, 2016.

Indeed, the experimenters utilized the above-mentioned conventional knowledge distillation techniques and an implementation of the retrospective knowledge distillation learning system 106 to train student networks from various teacher networks. Then, the experimenters utilized the student networks on the CIFAR-10, CIFAR-100, and TinyImageNet image datasets to evaluate the accuracy of the student networks. For example, the following Table 1 demonstrates accuracy metrics across the various baseline knowledge distillation techniques in comparison to the retrospective knowledge distillation (RetroKD) technique (in accordance with one or more implementations herein). In addition, Table 1 also demonstrates that increasing a teacher network size does not necessarily impact (or improve) student performance. As shown in Table 1, the RetroKD technique performed with greater accuracy (e.g., a higher value translates to greater accuracy) across many of the teacher networks compared to the baseline knowledge distillation approaches.

TABLE 1

| Dataset | Teacher | # params | BKD | NT | RetroKD |
|---|---|---|---|---|---|
| CIFAR-10 | CNN-4 | 37k | 70.94 | 71.22 | 72.08 |
| | CNN-8 | 328k | 72.50 | 72.46 | 72.67 |
| | CNN-10 | 2.48M | 72.51 | 72.62 | 73.17 |
| | ResNet-20 | 270k | 86.58 | 86.48 | 86.70 |
| | ResNet-32 | 464k | 86.53 | 86.57 | 86.74 |
| | ResNet-56 | 853k | 86.43 | 86.49 | 86.55 |
| CIFAR-100 | CNN-4 | 476k | 51.50 | 51.60 | 51.70 |
| | CNN-8 | 1.24M | 51.30 | 51.56 | 51.50 |
| | CNN-10 | 2.93M | 51.39 | 51.70 | 51.67 |
| | ResNet-20 | 276k | 56.86 | 56.35 | 57.37 |
| | ResNet-32 | 470k | 57.05 | 57.24 | 56.98 |
| | ResNet-56 | 859k | 56.45 | 56.67 | 57.19 |
| TinyImageNet | ResNet-20 | 282k | 37.44 | 37.59 | 37.74 |
| | ResNet-32 | 477k | 37.28 | 37.49 | 38.02 |
| | ResNet-56 | 865k | 37.61 | 37.46 | 37.60 |

In addition, the experimenters also utilized a function to understand the generalization of a student network through an approximation error. In particular, the experimenters utilized the following function, in which a student network ƒₛ∈ [symbol] ₛ having a capacity | [symbol] ₛ|_{C} is learning a real target function ƒ∈ [symbol] using cross entropy loss (without a teacher network). Indeed, the following function demonstrates the generalization bound of only the student network:

$$R ( {f}_{s} ) - R ( f ) \leq O ( \frac{{\vert {ℱ}_{s} \vert}_{C}}{{n}^{{ϛ}^{s}}} ) + {ϵ}_{s} \qquad ( 12 )$$

In the above-mentioned function (12), n is the number of data points and

$$\frac{1}{2} \leq {ϛ}^{s} \leq 1$$

is the rate of learning. Furthermore, the O(⋅) is the estimation error, ϵₛ is the approximation error of the student function class [symbol] ₛ, and R(⋅) is the distillation function.

Moreover, the experimenters also utilized a function to understand the generalization of a baselineKD (BKD) approach from both a teacher network ƒₜ∈ [symbol] ₜ and learning from cross entropy. Indeed, the experimenters utilized the following function for the generalization:

$$R ( {f}_{s} ) - R ( f ) = R ( {f}_{s} ) - R ( f ) + R ( {f}_{t} ) - R ( f ) \leq [ \text{} O ( \frac{{\vert {ℱ}_{s} \vert}_{C}}{{n}^{{ϛ}^{t}}} + \frac{{\vert {ℱ}_{s} \vert}_{C}}{{n}^{{ϛ}^{l}}} ) + {ϵ}_{t} + {ϵ}_{l} ] \leq [ \text{} O ( \frac{{\vert {ℱ}_{s} \vert}_{C}}{\sqrt{n}} ) + {ϵ}_{s} ] \qquad ( 13 )$$

In the above-mentioned function (13), a student network has a lower capacity than a teacher network | [symbol] ₛ|_{C}<<| [symbol] ₜ|_{C} and learns at a slow rate of learning

$$( i . e . , \frac{1}{2} \leq {ϛ}^{s} ) .$$

In addition, in the above-mentioned function (13), the teacher network is a high-capacity network with a near 1 rate of learning (i.e., ζ^{t}=1). In the function (13), if the student with a learning rate of ½ is to approximate the real function ƒ, then n^{ζ}^{^{l}}=\sqrt{n} in the right-hand side of the inequality. Indeed, the experimenters concluded that the inequality highlights the benefits of learning a low-capacity student network with a teacher, that is, it helps to generalize a student network better than learning the student network alone (i.e., (ϵₜ+ϵₗ)<<ϵₛ in function (13)).

In addition, the experimenters demonstrated how the RetroKD approach (in accordance with one or more implementations herein) improves the generalization bound (without a loss of generality). For example, the experimenters utilized the following function in which the past student network is ƒ_{ŝ}∈ [symbol] ₛ:

$$R ( {f}_{s} ) - R ( {f}_{\hat{s}} ) \leq O ( \frac{{\vert {F}_{s} \vert}_{C}}{{n}^{{ϛ}^{\hat{s}}}} ) + {ϵ}_{\hat{s}} \qquad ( 14 )$$

In addition, to demonstrate that the approximation error of the past student network helps minimize the error, the experimenters illustrated a theatrical result in the following function:

$${f}_{s}^{*} ≡ arg {min}_{f ∈ ℱ} R ( f ) s . t \frac{1}{K} {\sum }_{k} {( f ( {x}_{k} ) - {y}_{k} )}^{2} \leq ϵ \qquad ( 15 )$$

In the above-mentioned function (15), [symbol] : [symbol] → [symbol] is the space of all admissible functions from where we learn ƒₛ*. The finite dataset [symbol] ≡{xₖ,yₖ} has a K number of training points k={1, 2, . . . , K} and ϵ>0 as a desired loss tolerance. Indeed, without the loss of generality, function (15) can be represented as the following function:

$${f}_{s}^{*} = arg {min}_{f ∈ ℱ} \frac{1}{K} {\sum }_{k} {( f ( {x}_{k} ) - {y}_{k} )}^{2} + c {\int }_{x} {\int }_{x} u ( x , {x}^{†} ) f ( x ) f ( {x}^{†} ) {dxdx}^{†} \qquad ( 16 )$$

In the above-mentioned function (16), u(⋅) implies that ∀ƒₛ∈ [symbol] the R(ƒ)>0 with equality when ƒₛ(x)=0 and the c>0 . In addition, the function (16) can be represented as the following function:

ƒₛ*(x)=gₓ^{T}(cI+G)⁻¹y (17)

In the above-mentioned function (17),

$${g}_{x} [ k ] ≡ \frac{1}{k} g ( x , {x}_{k} ) , G [ j , , k ] ≡ \frac{1}{k} g ( {x}_{j} , {x}_{k} ) ,$$

and g(⋅) represents Green's function as described in Ebert et. al., Calculating Condensed Matter Properties Using the KKR-Green's Function Method—Recent Developments and Applications, Reports on Progress in Physics, 2011.

Indeed, in the above-mentioned function (17), the matrix G is positive definite and can be represented as G=V^{T}DV, the diagonal matrix D contains the eigenvalues and V includes eigenvectors. In addition, the experimenters demonstrated that at time t of the student network ƒₛ as described in the following function benefits from the previous round's t−1 knowledge distillation:

ƒ_{s,t}=gₓ^{T}(cI+G)⁻¹yₜ=gₓ^{T}V^{T}D(cₜI+D)⁻¹V_{y}_{_{t−1}} (18)

In the above-mentioned function (18), self distillation sparsifies (cI+G)⁻¹ at a given rate and ensures progressively limiting the number of basis function that acts as a good regularizer. As a result, the experimenters demonstrate that similar to function (13), the following function is utilized to understand the generalization of RetroKD (in accordance with one or more implementations herein):

$$R ( {f}_{s} ) - R ( f ) = {\underbrace{R ( {f}_{s} ) - R ( {f}_{\hat{s}} )}}_{Distillation from Past State} + {\underbrace{R ( {f}_{\hat{s}} ) - R ( {f}_{t} )}}_{Distillation from Teacher} + {\underbrace{R ( {f}_{t} ) - R ( f )}}_{Teacher Error} \leq O ( \frac{{\vert {ℱ}_{s} \vert}_{C}}{{n}^{{ϛ}^{\hat{s}}}} + \frac{{\vert {ℱ}_{t} \vert}_{C}}{{n}^{{ϛ}^{t}}} + \frac{{\vert {ℱ}_{s} \vert}_{C}}{{n}^{{ϛ}^{l}}} ) + {ϵ}_{t} + {ϵ}_{l} + {ϵ}_{\hat{s}} \qquad ( 19 )$$

Furthermore, in the above-mentioned function (19), the risk associated with the past state R(ƒ_{ŝ}) can be asymptotically equivalent to the present state student R(ƒₛ) as described by the following function:

$$O ( \frac{{\vert {ℱ}_{s} \vert}_{C}}{{n}^{{ϛ}^{\hat{s}}}} + \frac{{\vert {ℱ}_{t} \vert}_{C}}{{n}^{{ϛ}^{t}}} + \frac{{\vert {ℱ}_{s} \vert}_{C}}{{n}^{{ϛ}^{l}}} ) + {ϵ}_{t} + {ϵ}_{l} + {ϵ}_{\hat{s}} \leq O ( \frac{{\vert {ℱ}_{t} \vert}_{C}}{{n}^{{ϛ}^{t}}} + \frac{{\vert {ℱ}_{s} \vert}_{C}}{{n}^{{ϛ}^{l}}} ) + {ϵ}_{t} + {ϵ}_{l} \leq O ( \frac{{\vert {ℱ}_{s} \vert}_{C}}{\sqrt{n}} ) + {ϵ}_{s} \qquad ( 20 )$$

Indeed, utilizing the above-mentioned function (20), the approximation error ϵ_{ŝ} helps to reduce the training error in conjunction with the ϵₜ+ϵₗ and, accordingly, ϵₜ+ϵₗ+ϵ_{ŝ}≤ϵₜ+ϵₗ≤ϵₛ. As such, the upper bound of error in RetroKD (in accordance with one or more implementations herein) is smaller than its upper bound in BKD and with only the student network (i.e., without knowledge distillation) when n→∞. In some cases, RetroKD (in accordance with one or more implementations herein) also works in a finite range when the capacity of | [symbol] ₜ|_{C} is larger than | [symbol] ₛ|_{C} and the student network is distilling from its past state.

Additionally, the experimenters also demonstrated that student networks distilled using RetroKD (in accordance with one or more implementations herein) were more similar to corresponding teacher networks than when distilled using BKD. In particular, the experimenters utilized a Linear-CKA metric as described by Kornblith, et. al., Similarity of Neural Network Representations Revisited, International Conference on Machine Learning, 2019 to compare the similarity between student models trained using BKD and RetroKD (in accordance with one or more implementations herein) for convolutional features using a 20K sample from the training set of CIFAR-10.

Furthermore, the experimenters, under the observation that neural networks with better generalization have flatter converged solutions, demonstrated that student models trained with RetroKD (in accordance with one or more implementations herein) possess flatter minima. For example, using a point estimate to the flatness of a model can be determined using a measure of sharpness of the model (e.g., sharpness is considered opposite to flatness). In order to demonstrate the flatness of models trained using RetroKD (in accordance with one or more implementations herein), the experimenters computed sharpness over 2000 random training samples from the CIFAR-10 dataset for student models CNN-2 and ResNet-8.

Indeed, the following Table 2 demonstrates the results of the Linear-CKA similarity measurements and the sharpness measurements from the computations. As shown in Table 2, the RetroKD approach (in accordance with one or more implementations herein), in most cases, resulted in student networks that were more similar to the teacher networks (e.g., a higher similarity score) than the BKD method. As further shown in Table 2, the RetroKD approach (in accordance with one or more implementations herein), in most cases, resulted in student networks that had a lesser sharpness value (which translates to an increase in flatter convergence) compared to the BKD method.

TABLE 2

| | | Similarity (↑) | | Sharpness (↓) | |
|---|---|---|---|---|---|
| Student | Teacher | BKD | RetroKD | BKD | RetroKD |
| CNN-2 | CNN-4 | 0.1656 | 0.1728 | 338.82 | 380.36 |
| | CNN-8 | 0.2469 | 0.2658 | 733.68 | 681.33 |
| | CNN-10 | 0.2228 | 0.2217 | 763.38 | 722.82 |
| ResNet-8 | ResNet-20 | 0.7334 | 0.7355 | 611.73 | 551.83 |
| | ResNet-32 | 0.6771 | 0.6823 | 620.69 | 696.60 |
| | ResNet-56 | 0.6461 | 0.6615 | 751.54 | 613.12 |

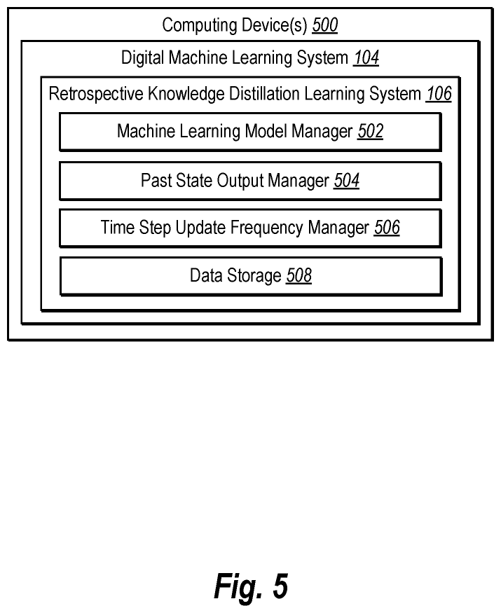

Turning now to FIG. 5, additional detail will be provided regarding components and capabilities of one or more embodiments of the retrospective knowledge distillation learning system. In particular, FIG. 5 illustrates an example retrospective knowledge distillation learning system 106 executed by a computing device 500 (e.g., the server device(s) 102 or the client device 110). As shown by the embodiment of FIG. 5, the computing device 500 includes or hosts the digital machine learning system 104 and the retrospective knowledge distillation learning system 106. Furthermore, as shown in FIG. 5, the retrospective knowledge distillation learning system 106 includes a machine learning model manager 502, a past state output manager 504, a time step update frequency manager 506, and data storage 508.

As just mentioned, and as illustrated in the embodiment of FIG. 5, the retrospective knowledge distillation learning system 106 includes the machine learning model manager 502. For example, the machine learning model manager 502 determines a retrospective knowledge distillation loss based on past state output logits of student machine learning models and teacher output logits of teacher machine learning models as described above (e.g., in relation to FIGS. 2-4). Furthermore, in some instances, the machine learning model manager 502 trains one or more machine learning models utilizing a retrospective knowledge distillation loss as described above (e.g., in relation to FIGS. 2-4).

Moreover, as shown in FIG. 5, the retrospective knowledge distillation learning system 106 includes the past state output manager 504. In some cases, the past state output manager 504 stores and accesses past states of student machine learning models as described above (e.g., in relation to FIGS. 2-4). In particular, in one or more embodiments, the past state output manager 504 utilizes a past state time step to receive historical output logits from past states (or historical time steps) of student machine learning models as described above (e.g., in relation to FIGS. 2-4).

Furthermore, as shown in FIG. 5, the retrospective knowledge distillation learning system 106 includes the time step update frequency manager 506. In some embodiments, the time step update frequency manager 506 selects past state time steps to utilize for determining a retrospective knowledge distillation loss as described above (e.g., in relation to FIGS. 4A-4B). In certain instances, the time step update frequency manager 506 utilizes a mathematical function (e.g., a remainder function) to update a past state through a checkpoint-update frequency value for the past state time step selection as described above (e.g., in relation to FIGS. 4A-4B).

As further shown in FIG. 5, the retrospective knowledge distillation learning system 106 includes the data storage 508. In some embodiments, the data storage 508 maintains data to perform one or more functions of the retrospective knowledge distillation learning system 106. For example, the data storage 508 includes machine learning models, machine learning model parameters, training data, past-state output logits, checkpoint-update frequency values, and/or other components of a machine learning model.

Each of the components 502-508 of the computing device 500 (e.g., the computing device 500 implementing the retrospective knowledge distillation learning system 106), as shown in FIG. 5, may be in communication with one another using any suitable technology. The components 502-508 of the computing device 500 can comprise software, hardware, or both. For example, the components 502-508 can comprise one or more instructions stored on a computer-readable storage medium and executable by processor of one or more computing devices. When executed by the one or more processors, the computer-executable instructions of the retrospective knowledge distillation learning system 106 (e.g., via the computing device 500) can cause a client device and/or server device to perform the methods described herein. Alternatively, the components 502-508 and their corresponding elements can comprise hardware, such as a special purpose processing device to perform a certain function or group of functions. Additionally, the components 502-508 can comprise a combination of computer-executable instructions and hardware.

Furthermore, the components 502-508 of the retrospective knowledge distillation learning system 106 may, for example, be implemented as one or more operating systems, as one or more stand-alone applications, as one or more modules of an application, as one or more plug-ins, as one or more library functions or functions that may be called by other applications, and/or as a cloud-computing model. Thus, the components 502-508 may be implemented as a stand-alone application, such as a desktop or mobile application. Furthermore, the components 502-508 may be implemented as one or more web-based applications hosted on a remote server. The components 502-508 may also be implemented in a suite of mobile device applications or “apps.” To illustrate, the components 502-508 may be implemented in an application, including but not limited to, ADOBE PHOTOSHOP, ADOBE PREMIERE, ADOBE LIGHTROOM, ADOBE ILLUSTRATOR, or ADOBE SUBSTANCE. “ADOBE,” “ADOBE PHOTOSHOP,” “ADOBE PREMIERE,” “ADOBE LIGHTROOM,” “ADOBE ILLUSTRATOR,” or “ADOBE SUBSTANCE” are either registered trademarks or trademarks of Adobe Inc. in the United States and/or other countries.

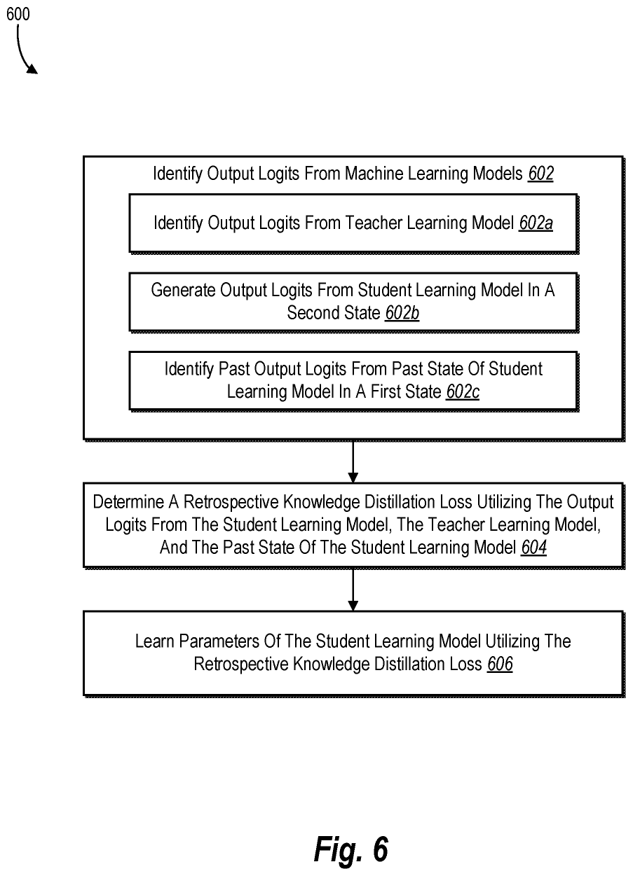

FIGS. 1-5, the corresponding text, and the examples provide a number of different methods, systems, devices, and non-transitory computer-readable media of the retrospective knowledge distillation learning system 106. In addition to the foregoing, one or more embodiments can also be described in terms of flowcharts comprising acts for accomplishing a particular result, as shown in FIG. 6. The acts shown in FIG. 6 may be performed in connection with more or fewer acts. Further, the acts may be performed in differing orders. Additionally, the acts described herein may be repeated or performed in parallel with one another or parallel with different instances of the same or similar acts. A non-transitory computer-readable medium can comprise instructions that, when executed by one or more processors, cause a computing device to perform the acts of FIG. 6. In some embodiments, a system can be configured to perform the acts of FIG. 6. Alternatively, the acts of FIG. 6 can be performed as part of a computer implemented method.

As mentioned above, FIG. 6 illustrates a flowchart of a series of acts 600 for regularizing learning targets for a student network by leveraging past state outputs of the student network with outputs of a teacher network to determine a retrospective knowledge distillation loss in accordance with one or more implementations. While FIG. 6 illustrates acts according to one embodiment, alternative embodiments may omit, add to, reorder, and/or modify any of the acts shown in FIG. 6.

As shown in FIG. 6, the series of acts 600 include an act 602 identifying output logits from machine learning models. For instance, the act 602 includes an act 602a of identifying output logits from a teacher machine learning model. In some cases, the act 602a includes generating output logits from a teacher machine learning model. In addition, the act 602 includes an act 602b of generating output logits from a student machine learning model in a second state. For example, the act 602b includes generating, in a second state, output logits from a student machine learning model. In some instances, the act 602b includes identifying output logits from a student machine learning model. In some cases, a student machine learning model is smaller in size than a teacher machine learning model.

Additionally, in one or more instances, the act 602c includes identifying past output logits from a past state of a student machine learning model in a first state. In some cases, the act 602c includes identifying past-state output logits (or historical output logits) from the student machine learning model in a first state (or historical time step of the student machine learning model). In one or more embodiments, the act 602c includes identifying additional past-state output logits of a student machine learning model generated utilizing student machine learning model parameters from a third state. For example, the third state occurs after a first state. Furthermore, the act 602c includes retrieving past-state output logits of student machine learning model generated utilizing student machine learning model parameters from a first state from stored memory corresponding to the student machine learning model. In some cases, the act 602c includes identifying historical output logits from a student machine learning model from an additional historical time step of the student machine learning model utilizing a checkpoint-update frequency value, in which the additional historical time step occurs after a historical time step.

Moreover, in one or more embodiments, the act 602c includes determining a time step of a third state utilizing a checkpoint-update frequency value. Indeed, in some cases, the act 602c includes determining a time step for a third state based on a remainder between a candidate time step and a checkpoint-update frequency value.

Furthermore, as shown in FIG. 6, the series of acts 600 include an act 604 of determining a retrospective knowledge distillation loss utilizing the output logits from the student machine learning model, the teacher machine learning model, and the past state of the student machine learning model. For example, the act 604 includes, in a second state, determining a retrospective knowledge distillation loss utilizing output logits of a student machine learning model and combined student-regularized teacher output logits based on output logits of a teacher machine learning model and past-state output logits of the student machine learning model generated utilizing student machine learning model parameters from a first state occurring before the second state. Moreover, in one or more embodiments, the act 604 includes determining a combined student-regularized teacher output logits utilizing an interpolation of output logits of a teacher machine learning model and past-state output logits of a student machine learning model generated utilizing student machine learning model parameters from a first state. Additionally, in certain instances, the act 604 includes determining an additional retrospective knowledge distillation loss utilizing additional output logits of a student machine learning model and additional combined student-regularized teacher output logits based on output logits of a teacher machine learning model and additional past-state output logits of a student machine learning model generated utilizing student machine learning model parameters from a third state.

In addition, in some cases, the act 604 includes generating student-regularized teacher output logits utilizing a combination of output logits from a teacher machine learning model during a second state and past-state output logits from a student machine learning model in a first state, the first state occurring prior to the second state. Moreover, in some instances, the act 604 includes determining a retrospective knowledge distillation loss between a teacher machine learning model and a student machine learning model by comparing student-regularized teacher output logits and output logits from a student machine learning model in (or during) a second state. In certain implementations, the act 604 includes generating, during a second state, student-regularized teacher output logits utilizing an interpolation of output logits from a teacher machine learning model and past-state output logits from a student machine learning model in a first state.

Moreover, in some implementations, the act 604 includes determining a retrospective knowledge distillation loss from output logits from a student machine learning model and combined student-regularized teacher output logits determined utilizing output logits from a teacher machine learning model and historical output logits from the student machine learning model. In some cases, the act 604 includes determining combined student-regularized teacher output logits utilizing an interpolation of output logits from a teacher machine learning model and historical output logits from a student machine learning model. Furthermore, in some embodiments, the act 604 includes determining an additional retrospective knowledge distillation loss from additional output logits from a student machine learning model and additional combined student-regularized teacher output logits determined utilizing output logits from a teacher machine learning model and additional historical output logits from the student machine learning model.

In some cases, the act 604 includes, prior to utilizing the retrospective knowledge distillation loss, determining a knowledge distillation loss utilizing (prior) outputs (or output logits) from a student machine learning model and outputs (or output logits) from a teacher machine learning model. Additionally, in some instances, the act 604 includes determining a student loss utilizing output logits from a student machine learning model and ground truth data.

In addition, as shown in FIG. 6, the series of acts 600 include an act 606 of learning parameters of a student machine learning model utilizing a retrospective knowledge distillation loss. Moreover, in one or more embodiments, the act 606 includes learning additional parameters of a student machine learning model utilizing an additional retrospective knowledge distillation loss. Furthermore, in some cases, the act 606 includes learning parameters of a student machine learning model utilizing a combination of a student loss and a retrospective knowledge distillation loss. Additionally, in some cases, the act 606 includes learning prior parameters of a student machine learning model utilizing a knowledge distillation loss.

Implementations of the present disclosure may comprise or utilize a special purpose or general-purpose computer including computer hardware, such as, for example, one or more processors and system memory, as discussed in greater detail below. Implementations within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, implementations of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some implementations, computer-executable instructions are executed by a general-purpose computer to turn the general-purpose computer into a special purpose computer implementing elements of the disclosure. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Implementations of the present disclosure can also be implemented in cloud computing environments. As used herein, the term “cloud computing” refers to a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In addition, as used herein, the term “cloud-computing environment” refers to an environment in which cloud computing is employed.

FIG. 7 illustrates a block diagram of an example computing device 700 that may be configured to perform one or more of the processes described above. One will appreciate that one or more computing devices, such as the computing device 700 may represent the computing devices described above (e.g., computing device 500, server device(s) 102, and/or client device 110). In one or more implementations, the computing device 700 may be a mobile device (e.g., a mobile telephone, a smartphone, a PDA, a tablet, a laptop, a camera, a tracker, a watch, a wearable device, etc.). In some implementations, the computing device 700 may be a non-mobile device (e.g., a desktop computer or another type of client device). Further, the computing device 700 may be a server device that includes cloud-based processing and storage capabilities.

As shown in FIG. 7, the computing device 700 can include one or more processor(s) 702, memory 704, a storage device 706, input/output interfaces 708 (or “I/O interfaces 708”), and a communication interface 710, which may be communicatively coupled by way of a communication infrastructure (e.g., bus 712). While the computing device 700 is shown in FIG. 7, the components illustrated in FIG. 7 are not intended to be limiting. Additional or alternative components may be used in other implementations. Furthermore, in certain implementations, the computing device 700 includes fewer components than those shown in FIG. 7. Components of the computing device 700 shown in FIG. 7 will now be described in additional detail.

In particular implementations, the processor(s) 702 includes hardware for executing instructions, such as those making up a computer program. As an example, and not by way of limitation, to execute instructions, the processor(s) 702 may retrieve (or fetch) the instructions from an internal register, an internal cache, memory 704, or a storage device 706 and decode and execute them.

The computing device 700 includes memory 704, which is coupled to the processor(s) 702. The memory 704 may be used for storing data, metadata, and programs for execution by the processor(s). The memory 704 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 704 may be internal or distributed memory.

The computing device 700 includes a storage device 706 includes storage for storing data or instructions. As an example, and not by way of limitation, the storage device 706 can include a non-transitory storage medium described above. The storage device 706 may include a hard disk drive (“HDD”), flash memory, a Universal Serial Bus (“USB”) drive or a combination these or other storage devices.

As shown, the computing device 700 includes one or more I/O interfaces 708, which are provided to allow a user to provide input to (such as user strokes), receive output from, and otherwise transfer data to and from the computing device 700. These I/O interfaces 708 may include a mouse, keypad or a keyboard, a touch screen, camera, optical scanner, network interface, modem, other known I/O devices or a combination of such I/O interfaces 708. The touch screen may be activated with a stylus or a finger.

The I/O interfaces 708 may include one or more devices for presenting output to a user, including, but not limited to, a graphics engine, a display (e.g., a display screen), one or more output drivers (e.g., display drivers), one or more audio speakers, and one or more audio drivers. In certain implementations, I/O interfaces 708 are configured to provide graphical data to a display for presentation to a user. The graphical data may be representative of one or more graphical user interfaces and/or any other graphical content as may serve a particular implementation.

The computing device 700 can further include a communication interface 710. The communication interface 710 can include hardware, software, or both. The communication interface 710 provides one or more interfaces for communication (such as, for example, packet-based communication) between the computing device and one or more other computing devices or one or more networks. As an example, and not by way of limitation, communication interface 710 may include a network interface controller (“NIC”) or network adapter for communicating with an Ethernet or other wire-based network or a wireless NIC (“WNIC”) or wireless adapter for communicating with a wireless network, such as a WI-FI. The computing device 700 can further include a bus 712. The bus 712 can include hardware, software, or both that connects components of computing device 700 to each other.

In the foregoing specification, the invention has been described with reference to specific example implementations thereof. Various implementations and aspects of the invention(s) are described with reference to details discussed herein, and the accompanying drawings illustrate the various implementations. The description above and drawings are illustrative of the invention and are not to be construed as limiting the invention. Numerous specific details are described to provide a thorough understanding of various implementations of the present invention.

The present invention may be embodied in other specific forms without departing from its spirit or essential characteristics. The described implementations are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A non-transitory computer-readable medium storing instructions that, when executed by at least one processor, cause the at least one processor to perform operations comprising:
generating output logits from a teacher machine learning model;
generating, in a second state, output logits from a student machine learning model;
determining a retrospective knowledge distillation loss utilizing the output logits of the student machine learning model and combined student-regularized teacher output logits based on the output logits of the teacher machine learning model and past-state output logits of the student machine learning model generated utilizing student machine learning model parameters from a first state, wherein the first state occurred before the second state; and
learning parameters of the student machine learning model utilizing the retrospective knowledge distillation loss.

2. The non-transitory computer-readable medium of claim 1, wherein the operations further comprise determining the combined student-regularized teacher output logits utilizing an interpolation of the output logits of the teacher machine learning model and the past-state output logits of the student machine learning model generated utilizing student machine learning model parameters from the first state.

3. The non-transitory computer-readable medium of claim 1, wherein the operations further comprise, prior to utilizing the retrospective knowledge distillation loss:
determining a knowledge distillation loss utilizing outputs from the student machine learning model and outputs from the teacher machine learning model; and
learning prior parameters of the student machine learning model utilizing the knowledge distillation loss.

4. The non-transitory computer-readable medium of claim 1, wherein the operations further comprise:
identifying additional past-state output logits of the student machine learning model generated utilizing student machine learning model parameters from a third state, wherein the third state occurs after the first state;
determining an additional retrospective knowledge distillation loss utilizing additional output logits of the student machine learning model and additional combined student-regularized teacher output logits based on the output logits of the teacher machine learning model and the additional past-state output logits of the student machine learning model generated utilizing the student machine learning model parameters from the third state; and
learning additional parameters of the student machine learning model utilizing the additional retrospective knowledge distillation loss.

5. The non-transitory computer-readable medium of claim 4, wherein the operations further comprise determining a time step of the third state utilizing a checkpoint-update frequency value.

6. The non-transitory computer-readable medium of claim 5, wherein the operations further comprise determining the time step for the third state based on a remainder between a candidate time step and the checkpoint-update frequency value.

7. The non-transitory computer-readable medium of claim 1, wherein the operations further comprise retrieving the past-state output logits of the student machine learning model generated utilizing student machine learning model parameters from the first state from stored memory corresponding to the student machine learning model.

8. The non-transitory computer-readable medium of claim 1, wherein the operations further comprise:
determining a student loss utilizing the output logits from the student machine learning model and ground truth data; and
learning the parameters of the student machine learning model utilizing a combination of the student loss and the retrospective knowledge distillation loss.

9. The non-transitory computer-readable medium of claim 1, wherein the student machine learning model comprises a smaller size than the teacher machine learning model.

10. A system comprising:
a memory component comprising a teacher machine learning model and a student machine learning model; and
a processing device coupled to the memory component, the processing device to perform operations comprising:
determining a retrospective knowledge distillation loss between the teacher machine learning model and the student machine learning model by:
identifying past-state output logits from the student machine learning model in a first state;
generating student-regularized teacher output logits utilizing a combination of output logits from the teacher machine learning model during a second state and the past-state output logits from the student machine learning model in the first state, wherein the first state occurs prior to the second state; and
comparing the student-regularized teacher output logits and output logits from the student machine learning model in the second state; and
learning parameters of the student machine learning model utilizing the retrospective knowledge distillation loss.

11. The system of claim 10, wherein the operations further comprise generating the student-regularized teacher output logits utilizing an interpolation of the output logits from the teacher machine learning model and the past-state output logits from the student machine learning model in the first state.

12. The system of claim 10, wherein the operations further comprise:
identifying additional past-state output logits of the student machine learning model generated utilizing student machine learning model parameters from a third state, wherein the third state occurs after the first state;
determining an additional retrospective knowledge distillation loss utilizing additional output logits of the student machine learning model and additional combined student-regularized teacher output logits based on the output logits of the teacher machine learning model and the additional past-state output logits of the student machine learning model generated utilizing the student machine learning model parameters from the third state; and
learning additional parameters of the student machine learning model utilizing the additional retrospective knowledge distillation loss.

13. The system of claim 12, wherein the operations further comprise determining a time step of the third state utilizing a checkpoint-update frequency value.

14. The system of claim 10, wherein the operations further comprise:
determining a student loss utilizing the output logits from the student machine learning model and ground truth data; and
learning the parameters of the student machine learning model utilizing a combination of the student loss and the retrospective knowledge distillation loss.

15. A computer-implemented method comprising:
identifying output logits from a teacher machine learning model;
identifying output logits from a student machine learning model;
determining a retrospective knowledge distillation loss from the output logits from the student machine learning model and combined student-regularized teacher output logits determined utilizing the output logits from the teacher machine learning model and historical output logits from the student machine learning model; and
learning parameters of the student machine learning model utilizing the retrospective knowledge distillation loss.

16. The computer-implemented method of claim 15, further comprising determining the combined student-regularized teacher output logits utilizing an interpolation of the output logits from the teacher machine learning model and the historical output logits from the student machine learning model.

17. The computer-implemented method of claim 15, further comprising, prior to utilizing the retrospective knowledge distillation loss:
determining a knowledge distillation loss utilizing the output logits from the teacher machine learning model and prior output logits from the student machine learning model; and
learning prior parameters of the student machine learning model utilizing the knowledge distillation loss.

18. The computer-implemented method of claim 15, further comprising identifying the historical output logits from the student machine learning model from a historical time step of the student machine learning model.

19. The computer-implemented method of claim 18, further comprising:
identifying additional historical output logits from the student machine learning model from an additional historical time step of the student machine learning model utilizing a checkpoint-update frequency value, wherein the additional historical time step occurs after the historical time step;
determining an additional retrospective knowledge distillation loss from additional output logits from the student machine learning model and additional combined student-regularized teacher output logits determined utilizing the output log its from the teacher machine learning model and the additional historical output logits from the student machine learning model; and
learning additional parameters of the student machine learning model utilizing the additional retrospective knowledge distillation loss.

20. The computer-implemented method of claim 15, further comprising:
determining a student loss utilizing the output logits from the student machine learning model and ground truth data; and
learning the parameters of the student machine learning model utilizing a combination of the student loss and the retrospective knowledge distillation loss.
